(19) United States
(12) Patent Application Publication
(10) Pub. No.: US 2022/0402106 A1
(43) Pub. Date: Dec. 22, 2022

(54) BOLT EXTRACTOR STRUCTURE

(71) Applicant: emoono CO., LTD., New Taipei City (TW)

(72) Inventors: PAI-CHIN CHEN, New Taipei City (TW); SHIUE-CHIAU LIU, New Taipei City (TW)

(21) Appl. No.: 17/349,922

(22) Filed: Jun. 17, 2021

(51) Int. Cl. B25B 27/02

(52) U.S. Cl. CPC B25B 27/02

(57) ABSTRACT

A bolt extractor structure includes: a main body, including a base plate, first wall, and second wall, both sides of the base plate vertically combined with the first wall and second wall, the first wall and second wall respectively provided with an opposite first shaft hole, each of the shaft holes provided with a first shaft, the first wall and second wall respectively having a first recess and second recess, and the first recess provided with an abutting element; and a hook body, one end thereof having a through hole, the first shaft passed through the through hole, another end of the hook body having a hooking portion.

### (A) TECHNICAL FIELD OF THE INVENTION

The present invention relates to a bolt extracting tool, and more particularly to a bolt extractor structure with a main body capable of providing abutment and a hook capable of pivoting.

### (B) DERIPTION OF THE PRIOR ART

Bolts and pins are commonly used connection elements, used to combine multiple parts into one body and very broad in the field of application, but the defect thereof is in that when the bolts and pins are assembled with interference fit, it is not easy to take them out.

### SUMMARY OF THE INVENTION

To overcome the above defect, the present invention proposes a bolt extractor structure, including: a main body, including a base plate, first wall, and second wall, both sides of the base plate vertically combined with the first wall and second wall, the first wall and second wall respectively provided with an opposite first shaft hole, each of the shaft holes provided with a first shaft, the first wall and second wall respectively having a first recess and second recess, and the first recess provided with an abutting element; and a hook body, one end thereof having a through hole, the first shaft passed through the through hole, another end of the hook body having a hooking portion.

### BRIEF DESCRIPTION OF THE DRAWINGS

FIG. 1 is a perspective view of the present invention; and

FIG. 2 is a top view of the present invention.

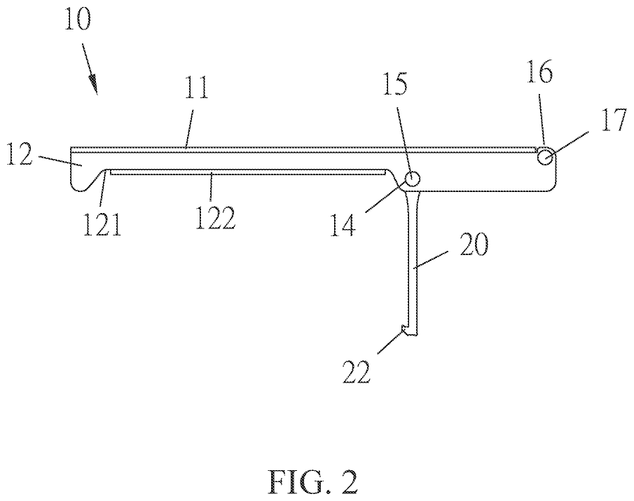

### DETAILED DESCRIPTION OF THE PREFERRED EMBODIMENTS

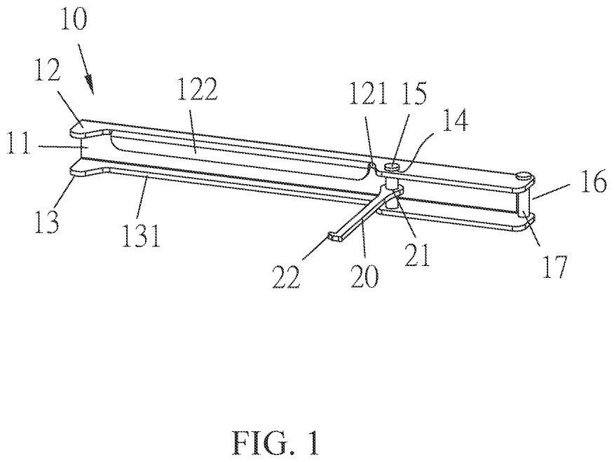

Referring to FIG. 1, a bolt extractor structure of the present invention includes a main body 10, and hook body 20.

The bolt 10 includes a base plate 11, first wall 12 and second wall 13, where both sides of the base plate 11 are vertically combined with the first wall 12 and second wall 13, and the first wall 12 and second wall 13 are respectively provided with an opposite first shaft hole 14, where each of the first shaft holes 14 is provided with a first shaft 15; the first wall 12 and second wall 13 respectively have a first recess 121 and second recess 131, and the first recess 121 is configured with an abutting element 122, where one side of the first recess 121 and one side of the second recess 131 ate close to the first shaft 15, and the abutting element 122 is perpendicular to the first wall 12 and parallel to the base plate 11.

One end of the hook body 20 has a through hole 21, through which the first shaft 15 is passed, and another end of the hook body 20 has a hooking portion 22, where the hooking portion 22 faces toward the abutting element 122.

Since the hook body 20 is coupled pivotally to the first shaft 15, the hook body 20 has 180 degrees pivoting range, the bolt extractor of the present invention can be operated in coordination with the environment space and an item having a bolt to be pulled out, can thus be used flexibly, so that the bolt can be easily pulled out.

Furthermore, the abutting element 122 can be used as a support point, making the pulling-out process more stable and labor-saving.

In addition, in the embodiment, the length of the base plate 11 is smaller that the one of the first wall 12 and the one of the second wall 12, so that one end of the first wall 12 and second wall 13 is formed a hollow portion 16 with the base plate 11, and one end of the first wall 12 and second wall 13 is provided ith a second shaft 17 positioned at the hollow portion 16.

With the above structure, a user can attach the hook body 20 to the first shaft 15 or the second shaft 17 according to the structure of an item having a bolt to be pulled out, and the pivoting range is greater than 180 degrees What the hook body 20 is coupled pivotally to the second shaft 17.

I claim:

1. A bolt extractor structure, comprising:
a main body, comprising a base plate, first wall, and second wall, both sides of said base plate vertically combined with said first wall and second wall, said first wall and second wall respectively provided with an opposite first shaft hole, each of said shaft holes provided with a first shaft, said first wall and second wall respectively having a first recess and second recess, and said first recess provided with an abutting element; and
a hook body, one end thereof having a through hole, said first shaft passed through said through hole, another end of said hook body having a hooking portion.

2. The structure according to claim 1, wherein a length of said base plate is smaller than a length of said first wall and a length of said second wall, allowing a hollow portion to be formed between one end of said first wall and second wall and one end of said base plate, said end of said first wall and second wall is provided with a second shaft positioned at said hollow portion.

3. The structure according to claim 2, wherein said hook body is configured on said first shaft or second shaft.

4. The structure according to claim 1, wherein one side of said first recess and second recess is close to said first shaft.

5. The structure according to claim 1, wherein said abutting element is perpendicular to said first wall and parallel to said base plate.

6. The structure according to claim 1, wherein said hooking portion faces toward said abutting element.

7. Abolt extractor structure, comprising:
a main body, comprising a base plate, first wall, and second wall, both sides of said base plate vertically combined with said first wall and second wall, said first wall and second wall respectively provided with an opposite first shaft hole, each of said shaft holes provided with a first shaft, said first wall and second wall respectively having a first recess and second recess, said first recess provided with an abutting element, a length of said base plate being smaller than a length of said first wall and a length of said second wall, allowing a hollow portion to be formed between one end of said first wall and said second wall and one end of said base plate, and said end of said first wall and second wall provided with a second shaft positioned at said hollow portion; and
a hook body; one end thereof having a through hole, said first shaft or second shaft passed through said through hole, another end of said hook body having a hooking portion.

8. The structure according to claim 7, wherein one side of said first recess and second recess is close to said first shaft.

9. The stiucture according to claim 7, wherein said abutting portion is perpendicular to said first wall and parallel to said base plate.

10. The structure according to claim 7, wherein said hooking portion faces toward said abutting element.
